(19) United States
(12) Patent Application Publication
(10) Pub. No.: US 2006/0073891 A1
(43) Pub. Date: Apr. 6, 2006

(54) Display with multiple user privacy

(76) Inventor: Timothy M. Holt, Newburyport, MA (US)

Correspondence Address: 3M INNOVATIVE PROPERTIES COMPANY, PO BOX 33427, ST. PAUL, MN, 55133-3427, US

(21) Appl. No.: 11/189,534

(22) Filed: Jul. 26, 2005

Related U.S. Application Data
(60) Provisional application No. 60/615,469, filed on Oct. 1, 2004.

(51) Int. Cl. A63F 13/00

(52) U.S. Cl. 463/30

(57) ABSTRACT

The present invention provides a display system that incorporates touch input, a community viewing regions, and multiple designated user regions that are viewable only from corresponding user positions. Systems of the present invention can be particularly useful in applications where it is desirable to provide for multiple users that can all view a common display region while being able to view their own designated display region and without being able to view another user's designated display region from their position. Systems of the present invention can also be of particular benefit in applications where it is desirable for users to be able to interact with the system via touch input. Examples of applications that can make use of various benefits provided by the present invention include multiple player games where all players have the ability to view game information common to all and each player has the ability to privately view game information specific to them.

### CROSS REFERENCE TO RELATED APPLICATION

This application claims the benefit of U.S. Provisional Patent Application No. 60/615,469, filed Oct. 1, 2004.

The present invention relates to systems that incorporate a display, touch input, and privacy.

### BACKGROUND

Electronic displays are widely used in all aspects of life. Although in the past the use of electronic displays has been primarily limited to computing applications such as desktop computers and notebook computers, as processing power has become more readily available, such capability has been integrated into a wide variety of applications. For example, it is now common to see electronic displays in applications as varied as automatic teller machines, gaming machines, automotive navigation systems, restaurant management systems, grocery store checkout lines, gas pumps, information kiosks, and hand-held data organizers, to name a few.

### SUMMARY

The present invention provides a display system that includes a display that incorporates a plurality of private viewing areas viewable only from associated viewing positions and a community viewing area viewable from all viewing positions. The display system also incorporates touch sensitive input via one or more touch panels overlaying at least a portion of the display.

### BRIEF DESCRIPTION OF THE DRAWING

The invention may be more completely understood in consideration of the following detailed description of various embodiments of the invention in connection with the accompanying drawings, in which:

FIG. 1 schematically shows an embodiment of a display system that incorporates multiple user privacy according to the present invention;

FIG. 2 schematically shows a cross-section of the system of FIG. 1 taken along line A-A;

FIG. 3 schematically shows a magnified cross-section of the portion of the cross-section indicated in FIG. 2; and

FIG. 4 schematically shows a touch sensitive input device useful in some embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention provides a display system that incorporates touch input and multiple designated user regions that are viewable only from corresponding user positions. Systems of the present invention can be particularly useful in applications where it is desirable to provide for multiple users that can all view a common display region while being able to view their own designated display region and being unable to view another user's designated display region from their position. Systems of the present invention can also be of particular benefit in applications where it is desirable for users to be able to interact with the system via touch input. Examples of applications that can make use of various benefits provided by the present invention include multiple player games where all players have the ability to view game information common to all and each player has the ability to privately view game information specific to them.

In the present invention, multiple users can view a display simultaneously. Portions of the display are visible to all users, and least one portion of the display is visible only to selected user position(s), and not visible to others. Card games such as Texas Hold'Em or other poker games may be played by multiple players using such a display equipped with privacy viewing and touch screen input capabilities.

Portions of the display can be made privately viewable from designated viewer positions by use of light control films (LCF), including those described as privacy films. LCF include films that allow viewing within a viewable range and block light outside of the viewable range. LCF also include films that redirect light that would otherwise be displayed outside of a viewable range back into the viewable range. Examples of LCF include micro-louvered films, micro-structured and micro-grooved films including a light absorbing filler material, various commercially available LCF products and privacy films such as those sold by 3M Company under the Vikuiti™ brand, various light directing films and lenses such as Fresnel lenses, turning films, prismatic films, and the like. In constructions useful in the present invention, LCF may be located over, under, or within a display structure, and may be incorporated into a touch input device. Because many types of LCF control the viewing angle in a single direction, it can be useful to provide at least two LCF components oriented so that privacy can be provided horizontally and vertically, and so that the central axis of viewability can be directed at the designated viewing position. Examples of LCF and LCF constructions are disclosed in U.S. Pat. Nos. 4,553,818; 4,764,410; 4,812,709; 5,147,716; 5,254,388; 5,528,319; 6,120,026; and 6,398,370, in U.S. Patent Application Publication US 20030210535, and in International Publications WO 2002099479 and WO 2004036286, each of which is wholly incorporated into this document.

As indicated, LCF can be used to control light within a range of angles horizontally and/or a range of angles vertically, for example centered around a central axis of viewability. LCF can also be used to determine the position of the central axis of viewability. The viewable area created by LCF can be fan shaped or conical. In applications where it is desirable for users to be able to view information privately from other users that may be positioned to the left, right, and across from them, it is preferable to control the horizontal and vertical viewing angle as well as the viewing axis.

Privacy films and image directing films such as the micro-louvered and micro-structured films commercially available from 3M Company can be positioned in, under, or over a display, or designated portions of a display, to limit the viewable angle of the display or the designated portions. Privacy films and image directing films can also be used to direct the displayed image in a certain direction or at a certain angle. Image directing films generally control the viewing angle or cone of a display. LCF can be placed over portions of a display to limit visibility of that portion to one of several players.

Use of player privacy with a display can allow card games, for example, that currently require an in-person dealer and a physical set of playing pieces (e.g., a deck of cards) to now be automated using a video system that provides for individual users' private viewing of their playing pieces while giving all players a view of a common set of playing pieces. One example is the game Texas Hold'Em that employs a set of community cards used by all players in combination with two cards dealt face down to each player that are for that player's private viewing and information. In the present invention, the community cards can be displayed in a central region viewable to all players (as well as spectators), and each player's private cards can be displayed in a region in which only a single player positioned within a specified viewing region can view the cards. At some point in a game, it may be desired that one or more of the players show their cards, in which case their cards can be moved to an area of the display viewable to all players.

The additional provision of touch input in a display system that incorporates private viewing areas allows unique modes of interaction. In particular, a touch panel or set of touch panels capable of measuring multiple simultaneously touched points can add further to the game options. A touch panel equipped display that has private and public touch and viewing areas further expands playing options, for example any game where each player is given a certain amount of knowledge that is not revealed to the other players can benefit from the present invention, such as card games in general, including poker games such as Texas Hold'Em, popular board games such as Scrabble™, Battleship™, or Mastermind™ that are translated into video games, trivia games, and the like.

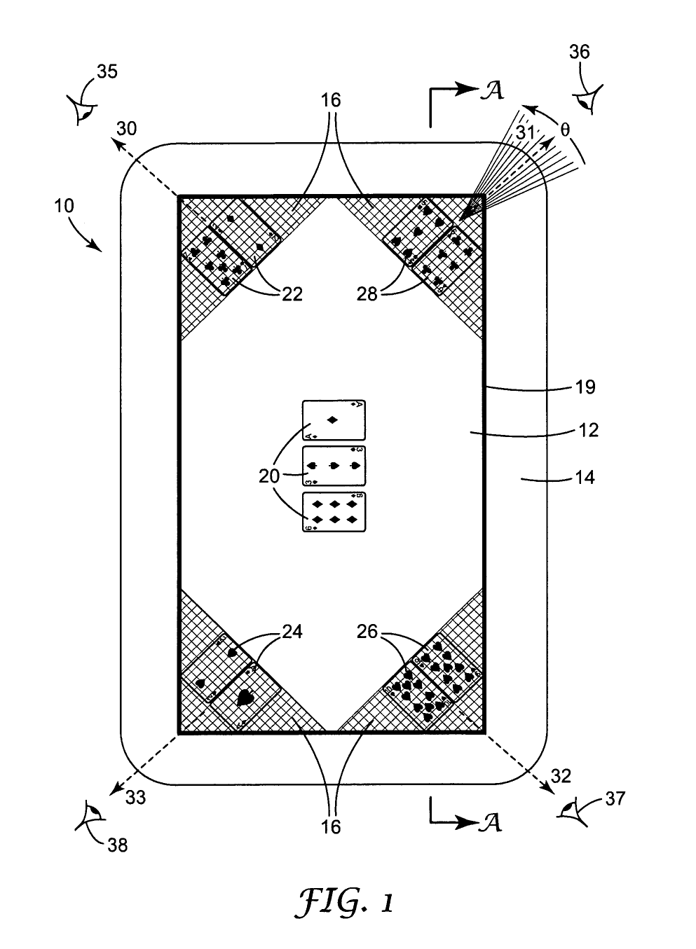

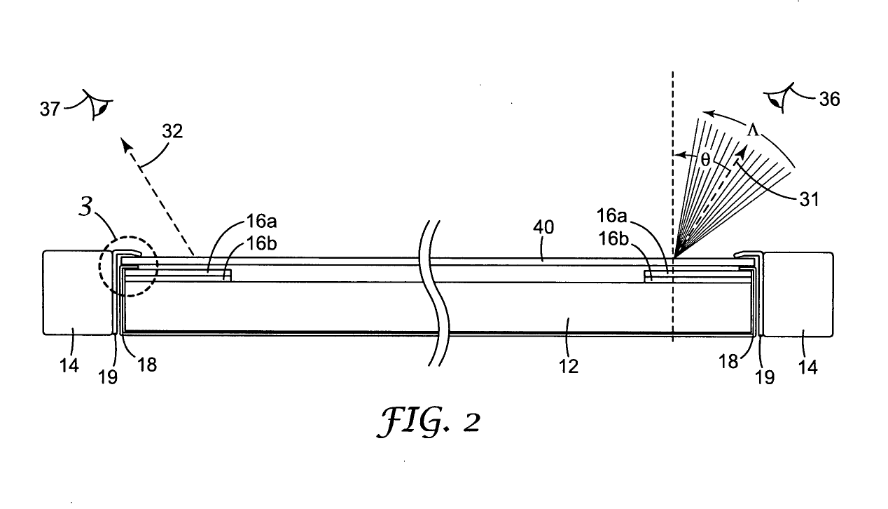

Various aspects of an embodiment of the present invention are shown and described with reference to FIGS. 1-3. It is understood that the embodiment shown is illustrative, and not reflective of all the various embodiments contemplated, which can be appreciated by the descriptions provided herein. FIG. 1 schematically depicts a video game system 10 having a display 12 mounted horizontally in table 14. Each of the four corners of display 12 are provided with LCF privacy filter assemblies 16, as described in more detail in discussions that follow. Filter assemblies 16 direct light toward each viewing position 35, 36, 37 and 38 as indicated by arrows 30, 31, 32 and 33, respectively. Objects or information displayed in the regions that include the LCF filter assemblies 16 are viewable only by a person located in one of the viewing positions 35, 36, 37 or 38. Filter assemblies 16 control the viewing axis, horizontal viewing angle and vertical viewing angle, as will be appreciated at least from FIGS. 1 and 2.

Display 12 can be inserted into a custom-build poker table 14 to create a tabletop game. Display 12 can be any suitable electronic display including a cathode ray tube (CRT), liquid crystal display (LCD), projection display, plasma display, or the like. Display 12 may also include multiple display units and/or may also incorporate or display images through and around static graphics.

The game indicated in FIG. 1 is Texas Hold'Em poker where the individual player's cards can be dealt into their respective private corners. Because the system provides privacy, each player's individual cards may be dealt face up. In other embodiments, it may be desirable to deal each player's individual cards face down and allow the player to alternately reveal and hide the cards by touching a touch screen overlay. FIG. 1 depicts the display 12 revealing cards 20 arranged as the “flop” in a game of Texas Hold'Em, and cards 22, 24, 26 and 28 are revealed to individual players in the private regions 16. As shown, up to four people arranged in positions 35, 36, 37 and 38 may play, although embodiments accommodating more players are also contemplated (for example, eight players, one at each corner and one at each side of a square table top video display). Cards 20 are in the public area of the game, so they may be viewed by any player. Cards 22, 24, 26 and 28 are displayed behind filter assemblies 16 so they may be viewed only from viewpoints 35, 38, 32 and 36, respectively. FIG. 1 also indicates the horizontal viewing angle range Φ indicated for viewing position 36. The horizontal viewing angle Φ can be selected to accommodate relatively facile viewing from the designated viewing position while still offering sufficient privacy from the wandering gaze of other players or their cohorts. For example, Φ can be selected to allow a viewing angle of about 10° to 100°.

FIG. 2 schematically depicts a cross-sectional view of game table 10 taken along line A-A in FIG. 1. FIG. 2 indicates the vertical viewing angle Λ as seen from viewing position 36 and controlled by filter assemblies 16, as well as the tilt angle Θ of the viewing cone as measured from an axis perpendicular to the plane of the display. Like the horizontal viewing angle, the vertical viewing angle Λ and cone tilt angle Θ can be selected to accommodate viewability for a user in a designated position while still providing privacy from others. In exemplary embodiments, Λ can be selected to be in a range of about 10° to 100° wide, and Θ can be selected to be in a range of about 20° to 70° from perpendicular.

The display 12 is surrounded by an internal metal bezel 19 and a plastic cosmetic bezel 18. LCF assemblies that include a first LCF member 16a and a second LCF member 16b, both positioned between the top surface of the display 12 and the internal bezel 19, create private viewing areas. Private viewing areas in each corner of display 12 can be formed by an assembly of two crossed layers of micro-louvered Vikuiti™ Light Control Film commercially available from 3M Company. LCF layer 16b can have a horizontal viewing cone Φ of about 60° with a 0° tilt, and LCF layer 16a can have a vertical viewing cone Λ of 48° with a vertical tilt Θ of 30°. LCF assemblies 16 can be held in place by pressure between inner metal bezel 18 and the top surface of display 12. Alternatively, LCF assemblies 16 can be laminated or otherwise bonded to any surface of touch screen 40 (e.g., upper surface, lower surface, or intermediate surface in the case of a multiple layer touch screen construction) or to any suitable surface of display 12 such as its top surface. LCF assemblies can also be laminated to or in other elements (not shown) such as graphics inserts, optical films, support structures, and the like. An optical adhesive may be suitably used to bond the LCF assemblies to other elements, or to bond layers of the LCF assemblies to each other.

FIG. 2 also indicates that a touch screen 40 can be positioned over display 12 to allow direct interaction with displayed objects such as cards 20, 22, 24, 26 and 28. Although touch screen 40 is shown to cover the entire display area, it is also contemplated that one or more touch screens can be disposed in selected areas over the display. For example, individual touch screens can be placed in each designated user area so that each user has access to their own touch screen that can be independently operated. This can be beneficial particularly when using touch sensing technologies that have difficulties in resolving multiple simultaneous touch inputs on the same touch surface. Having separate touch screens dedicated to each user can allow the users to interact with the system via the touch screen at any time without concern that another user's activity may be interfering. In embodiments where a single touch screen is disposed over the entire display area, the entire surface of the touch screen can be available for touch inputs, or specified portions of the touch screen can be designated as touch input regions thereby creating active and inactive touch regions. Portions of a touch screen can be made inactive either by not including the touch sensing element in those areas, or through electronic means by appropriately taking account of or ignoring signals generated from touches in the inactive areas, for example through programmed software or firmware.

Any touch screen technology now know or later developed that can be used in conjunction with a display can be suitably used in the present invention. Touch technologies include capacitive, projected capacitive, resistive, infrared beam, surface acoustic wave, force, and vibration. In embodiments that provide for multiple users positioned around a large format video display, and in which it is desirable to provide a single touch input device covering the entire display, touch screens capable of functioning over large areas may be particularly useful. For example, vibration-sensing touch input devices can be used in large formats as disclosed in co-assigned U.S. patent applications U.S. Ser. No. 10/850,324 and U.S. Ser. No. 10/850,516, which are wholly incorporated into this document.

While touch input devices can provide a convenient and intuitive way to interact with video systems of the present invention, other user input devices can also be used in place of or in addition to touch screens disposed over the displays. Examples include off-display touch pads, membrane switches, buttons, joysticks, toggle switches, track balls, and so forth.

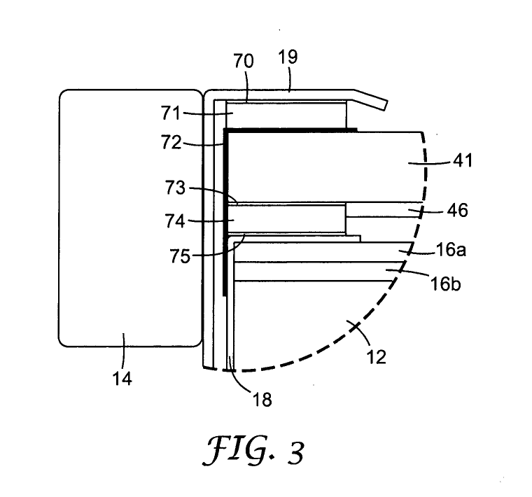

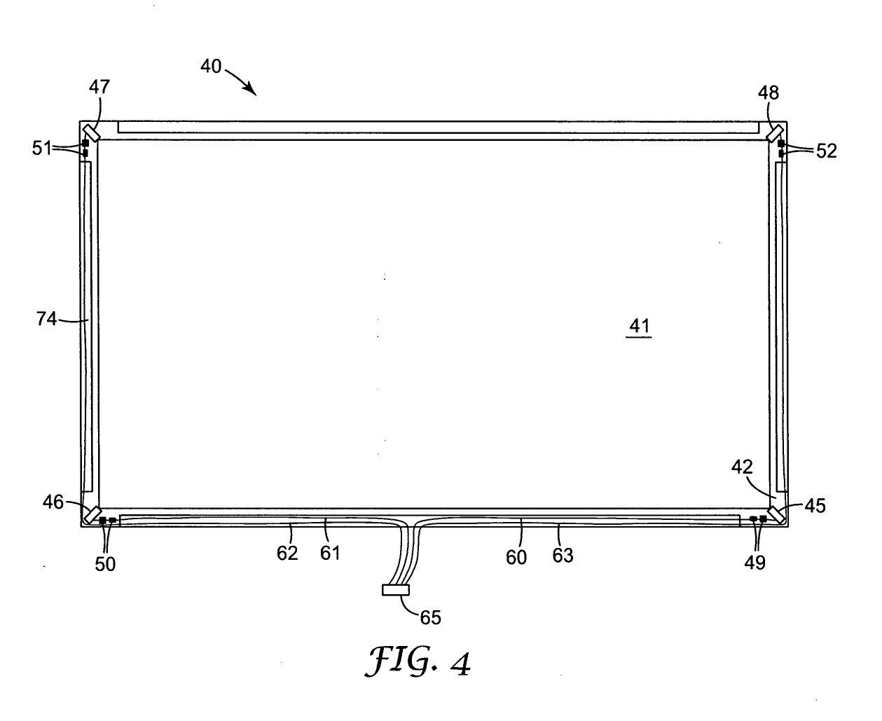

FIG. 3 schematically depicts an expanded cross-sectional view of the portion indicated in FIG. 2. Additional detail of the layered construction is shown. Spacers 71 and 74 are provided, which can include resilient materials such as foam type, for example Poron foam tape, number 4790-92-20081-04S. Spacer 71 can be bonded to bezel 19 using any suitable adhesive, for example 3M 467MP adhesive. The bottom side of spacer 71 rests on copper tape 72. Copper tape 72 adheres to the top and side surfaces of glass panel 41, and to metal inner bezel 18. When a touch panel such as that shown in FIG. 4 is used, copper tape 72 can shield touch screen components 45, 46, 47 and 48 and 49, 50, 51 and 52, as well as interconnect wires 60, 61, 62 and 63 (see FIG. 4) from electromagnetic interference. Spacer 74 can be bonded to panel 41 with adhesive 73, and spacer 74 is also bonded to inner bezel 18 with an adhesive 75 such as 3M 4936VHB. LCF films 16a and 16b are held in place between display 12 top surface and inner bezel 18 by pressure and friction.

FIG. 4 schematically depicts a vibration-sensing touch panel 40 useful in providing touch input in some embodiments of the present invention. Exemplary vibration-sensing touch panels are disclosed in International Publications WO 96/11378, WO 00/38104, WO 01/48684, WO 02/01490, WO 03/005292, WO 03/067511, WO 03/107261, European Patent EP 1 240 617 B1, commonly assigned U.S. patent applications U.S. Ser. No. 10/729,540, U.S. Ser. No. 10/750,290, U.S. Ser. No. 10/750,291 and U.S. Ser. No. 10/750,502, U.S. Patent Publications US 20030066692 and US 20020135570, and U.S. Pat. Nos. 5,637,829 and 5,717,432, each of which is wholly incorporated into this document. In one embodiment, panel 41 is a semi-strengthened rectangular glass panel having the dimensions 915 mm long×560 mm wide×2.2 mm thick. Piezoelectric transducers 45, 46, 47 and 48 can be bonded to the bottom surface of glass panel 41 at the corners with cyano-acrylate glue. In this embodiment, sensors 45, 46, 47 and 48 measure 10.4 mm×4.5 mm×1.19 mm. The sensors are oriented with their long axes at 45° with respect to the adjacent glass panel edges, as disclosed in WO 03/005292 and commonly-assigned U.S. Ser. No. 10/440,650, which is wholly incorporated by reference herein. Sensors 45, 46, 47 and 48 are constructed in the a series capacitor configuration as disclosed in commonly-assigned U.S. Ser. No. 10/739,471, which is wholly incorporated by reference herein.

In brief, vibration-sensing touch input devices generally function by detecting vibrations in a touch plate caused by a touch, input from a vibrating touch implement, or already propagating in the plate and altered by the touch. The detected vibrations can be used to determine the position of the touch. In some variations, piezoelectric transducers are coupled to the touch plate to detect bending wave vibrations. The transducers pick up the vibrations and generate signals that are transmitted to controller electronics. The action of touching the input surface of the plate generates an impulse of energy whose bandwidth and amplitude depend on the contact material (finger, stylus, glove, etc.), the plate material (glass, acrylic, etc.), and the strength of contact. The energy imparted at the contact point propagates towards the transducers, generally located at various points around the periphery of the touch plate (such as at the comers of a rectangular plate), which generate a signal that can be digitized. The controller electronics can run calculations on the digitized signal to determine the location of the touch impact, or other information related to the touch such as the strength of the touch, the type of touch implement, and so forth. Vibration-sensing touch devices can also detect vibrations generated by a touch implement being traced across the input surface of the touch plate due to frictional contact between the touch implement and the surface of the panel.

Because vibrations indicative of a touch input generally include bending wave vibrations that are susceptible to dispersion during propagation, it may be desirable to correct for dispersion effects that may otherwise give rise to errors in the input position or other determined information. Exemplary methods for correcting for dispersion effects are disclosed in WO 01/48684.

Referring back to FIG. 4, signals generated by each of sensors 45, 46, 47 and 48 in response to vibrations in the glass panel 41 due to touch inputs can be buffered by FET amplifier circuit components 49, 50, 51 and 52 respectively. Four cables 60, 61, 62 and 63 can be used to carry signals from the sensor and components at each corner of panel 41 to connector 65, for example. Each cable having one twisted pair of wires. Alternatively, the wired interconnects may be replaced by printed conductive ink traces terminated at an electronic tail.

FIG. 4 also indicates that spacer 74 can be provided on the panel 41. In addition to providing a spacing function, spacer 74 can also provide a vibration damping function when the touch input device 40 is integrated into a video system. It is often desirable to at least partially isolate a vibration-sensing touch input device from sources of external vibrations and/or to provide for absorption of vibrations at the edges of the touch plate to reduce reflections. Acoustic barrier materials can also be provided separate from the spacer function. Exemplary acoustic barrier materials may include various foam tapes such as acrylic foam tapes, double-sided adhesive tapes such as those sold by 3M Company under the trade designations 3M 4956 and 3M 5962, urethane foam tapes, single-coated tapes such as those sold by 3M Company under the trade designation 3M 4314, and the like. Other materials that may be suitable include various urethanes and silicones, as well as viscoelastic materials useful for vibration damping applications.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A display system comprising:
a display having a community viewing region and a plurality of designated private viewing regions, wherein each private viewing region is viewable only from an associated viewing position and the community viewing region is viewable from all viewing positions; and
a touch sensitive input device overlaying at least a portion of the display to provide for user interaction with the display system.

2. The display system of claim 1, further comprising a light control film assembly disposed in at least one of the private viewing regions to control the viewability of the display.

3. The display system of claim 2, wherein the light control film assembly comprises a first light control film that controls viewing angle in a first direction and a second light control film that controls viewing angle in a second direction perpendicular to the first direction.

4. The display system of claim 3, wherein at least one of the first and second light control films controls a viewing axis determined by a tilt angle measured toward the associated viewing position from a line perpendicular to the display.

5. The display system of claim 1, wherein the system is configured as a table around which the associated viewing positions are distributed to accommodate a plurality of users.
